(19) United States
(12) Patent Application Publication
(10) Pub. No.: US 2022/0402759 A1
(43) Pub. Date: Dec. 22, 2022

(54) HEXAGONAL BORON NITRIDE POWDER

(71) Applicant: DENKA COMPANY LIMITED, Chuo-ku, Tokyo (JP)

(72) Inventors: Go TAKEDA, Chuo-ku, Tokyo (JP); Masao TSUICHIHARA, Chuo-ku, Tokyo (JP); Takaaki TANAKA, Chuo-ku, Tokyo (JP)

(73) Assignee: DENKA COMPANY LIMITED, Chuo-ku, Tokyo (JP)

(21) Appl. No.: 17/777,521

(22) PCT Filed: Nov. 12, 2020
(86) PCT No.: PCT/JP2020/042337

§ 371 Date: May 17, 2022

(30) Foreign Application Priority Data
Nov. 19, 2019 (JP) 2019-208514

(51) Int. Cl. C01B 21/064

(52) U.S. Cl. CPC C01B 21/0645; C01P 2002/76; C01P 2006/80; C01P 2006/12; C01P 2004/61

(57) ABSTRACT

One aspect of the present disclosure provides a hexagonal boron nitride powder having a purity of 98 mass % or more and a specific surface area of less than 2.0 m²/g.

### TECHNICAL FIELD

The present disclosure relates to a hexagonal boron nitride powder.

### BACKGROUND ART

Boron nitride is excellent in lubricating properties, high heat conductive properties, insulating properties, and the like. Accordingly, the boron nitride is used in various applications such as a solid lubricant, a mold release material with respect to melted gas, aluminum, and the like, a filling material for a heat dissipating material, and a raw material for a sintered body.

A boron nitride powder is used as a mold release material in mold casting of magnesium, aluminum, an aluminum alloy, and the like. For example, the boron nitride powder is mixed with water together with a dispersant to prepare slurry, and the slurry is applied onto the surface of a mold and baked, and thus, is used for providing a mold release layer (for example, refer to Patent Literature 1, Patent Literature 2, and the like). The shape of the mold has been complicated and precise, and the boron nitride powder used as the mold release material is required to be more excellent in mold release properties.

The boron nitride powder is used as a heat dissipating material by improving crystallizability. Primary particles of boron nitride with improved crystallizability and grain growth are in the shape of a scale. Accordingly, the primary particles of the boron nitride have thermal anisotropy derived from the shape. The boron nitride may be used as aggregated particles by aggregating the primary particles described above, from the viewpoint of reducing the influence of the anisotropy. A technology of producing the aggregated particles by controlling a particle diameter of the primary particles to be small is known (for example, Patent Literature 3). In addition, a technology of producing submicron spherical boron nitride fine particles with a high sphericity, which are used as a filling material for a heat dissipating material, is known (for example, Patent Literature 4).

### CITATION LIST

### Patent Literature

Patent Literature 1: Japanese Unexamined Patent Publication No. S55-29506

Patent Literature 2: Japanese Unexamined Patent Publication No. S63-270798

Patent Literature 3: Japanese Unexamined Patent Publication No. 2016-60661

Patent Literature 4: International Publication WO. 2015/122379

### SUMMARY OF INVENTION

### Technical Problem

An object of the present disclosure is to provide a versatile hexagonal boron nitride powder. In addition, another object of the present disclosure is to provide a production method for the hexagonal boron nitride powder as described above.

### Solution to Problem

One aspect of the present disclosure provides a hexagonal boron nitride powder having a purity of 98 mass % or more and a specific surface area of less than 2.0 m²/g.

The hexagonal boron nitride powder described above has a high purity and a specific surface area of less than 2.0 m²/g, and thus, may be used in various applications. For example, in a case where the hexagonal boron nitride powder is used as a mold release material, since a specific surface area is small, a dense mold release layer may be formed, and excellent mold release properties may be exhibited. In addition, for example, even in a case where the hexagonal boron nitride powder is used as a heat dissipating filler, since demand characteristics for the hexagonal boron nitride powder are in common with those of the mold release material, a purity is high, and a specific surface area is small, filling properties are excellent, and excellent filler characteristics may also be exhibited. Further, even in a case where the hexagonal boron nitride powder is used in a cosmetic application, similarly, since a purity as hexagonal boron nitride is higher, and a specific surface area is small, a preferred raw material excellent in reliability may be obtained.

In the hexagonal boron nitride powder described above, a total content of sodium and calcium may be less than 50 ppm, or may be 30 ppm or less. Since the total content of sodium and calcium in the hexagonal boron nitride powder is in the range described above, for example, the impregnation or the like of metal impurities with respect to a product may be further suppressed, and thus, the hexagonal boron nitride powder is useful as a mold release material that is used for producing an electronic material. Since the total content of sodium and calcium in the hexagonal boron nitride powder is in the range described above, heat conductive properties may be further improved, and thus, the hexagonal boron nitride powder is also useful as a heat dissipating material.

In the hexagonal boron nitride powder described above, an average particle diameter of primary particles may be 2.0 to 35 μm, and the average particle diameter of the primary particles may be 9.0 to 30 μm. Since the average particle diameter of the primary particles is in the range described above, a denser mold release layer may be formed, and thus, the hexagonal boron nitride powder is more useful as a mold release material.

### Advantageous Effects of Invention

According to the present disclosure, it is possible to provide a versatile hexagonal boron nitride powder. In addition, according to the present disclosure, it is possible to provide a production method for the hexagonal boron nitride powder as described above.

According to the present disclosure, for example, it is possible to provide a hexagonal boron nitride powder useful in a mold release material and the like.

### DESCRIPTION OF EMBODIMENTS

Hereinafter, an embodiment of the present disclosure will be described. Here, the following embodiment is an example for describing the present disclosure and does not limit the present disclosure to the following contents.

Herein, a numerical range represented by “◯◯ to ΔΔ” indicates “◯◯ or more and ΔΔ or less”, unless otherwise noted. Herein, “parts” or “%” are based on a mass, unless otherwise noted. In addition, herein, the unit of a pressure is a gauge pressure, unless otherwise noted, and a notation such as “G” or “gage” will be omitted.

Only one type of materials exemplified herein can be used, or two or more types thereof can be used in combination, unless otherwise noted. In a case where there are a plurality of substances corresponding to each component in a composition, the content of each component in the composition indicates the total amount of the plurality of substances in the composition, unless otherwise noted.

One embodiment of a hexagonal boron nitride powder has a purity of 98 mass % or more and a specific surface area of less than 2.0 m²/g. The hexagonal boron nitride powder described above may be used in various applications, and for example, may be used in various applications such as a solid lubricant, a mold release material, a filling material for a heat dissipating material, a cosmetic raw material, and a raw material for a sintered body.

A lower limit value of the purity of the hexagonal boron nitride powder is 98 mass % or more, and for example, may be 99 mass % or more. Since the purity of the hexagonal boron nitride powder is in the range described above, a decrease in a melting point due to impurities is suppressed, and thus, for example, in a case where the hexagonal boron nitride powder is used as a mold release material, mold release properties may be sufficiently maintained even when used at a high temperature. The purity of the hexagonal boron nitride powder is measured by a method described in Examples of this specification.

An upper limit value of the specific surface area of the hexagonal boron nitride powder is less than 2.0 m²/g, and for example, may be 1.5 m²/g or less, or 0.8 m²/g or less. A lower limit value of the specific surface area, for example, may be 0.1 m²/g or more, 0.2 m²/g or more, or 0.3 m²/g or more. The specific surface area may be adjusted in the range described above, and for example, may be 0.1 m²/g or more and less than 2.0 m²/g, or 0.2 to 1.5 m²/g or more. The specific surface area of the hexagonal boron nitride powder, for example, may be controlled by adjusting a heating temperature and a heating time when forming primary particles by performing a heating treatment with respect to a raw material powder.

Herein, the specific surface area of the hexagonal boron nitride powder is measured by using a measurement device, on the basis of JIS Z 8803:2013. The specific surface area is a value calculated by applying a BET one point method using nitrogen gas.

An upper limit value of an average particle diameter of the primary particles in the hexagonal boron nitride powder, for example, may be 35 μm or less, 30 μm or less, 25 μm or less, or 20 μm or less. Since the upper limit value of the average particle diameter of the primary particles is in the range described above, for example, adhesiveness to a casting mold and a mold release layer may be further improved when used as a mold release material. In addition, handleability when used as a filling material for a heat dissipating material may be improved by decreasing the upper limit value of the average particle diameter of the primary particles. A lower limit value of the average particle diameter of the primary particles, for example, may be 2.0 μm or more, 4.0 μm or more, 6.0 μm or more, or 9.0 μm or more. Since the lower limit value of the average particle diameter of the primary particles is in the range described above, for example, a denser mold release layer may be formed when used as a mold release material. The average particle diameter of the primary particles may be adjusted in the range described above, and for example, may be 2.0 to 35 μm, 2.0 to 30 μm, or 9.0 to 30 μm. The average particle diameter of the primary particles, for example, may be controlled by adjusting the composition of the raw material powder, a firing time of the raw material powder, and the like.

Herein, the average particle diameter of the primary particles is measured by using a particle size distribution measurement device (Product Name: MT3300EX, manufactured by NIKKISO CO., LTD.), on the basis of ISO 13320:2009. The average particle diameter obtained by the measurement described above is an average particle diameter according to a volume statistical value, and the average particle diameter is a median value (d50). In the particle size distribution measurement, water is used as a solvent in which an aggregated body is dispersed, and a hexametaphosphoric acid is used as a dispersant. At this time, a numerical value of 1.33 is used as a refractive index of water, and a numerical value of 1.80 is used as a refractive index of the hexagonal boron nitride powder.

In the hexagonal boron nitride powder, the content of sodium and calcium may be low. The total content of sodium and calcium, for example, may be less than 50 ppm, 40 ppm or less, 35 ppm or less, 30 ppm or less, 20 ppm or less, or 10 ppm or less. In addition, the total content of sodium and calcium may be less than or equal to a detection limit according to a detection device. Since the total content of sodium and calcium is in the range described above, for example, the occurrence of color unevenness on the surface of a product due to the influence of metal impurities, the occurrence of a decrease in insulating characteristics due to the transition of the metal impurities to the product, and the like may be reduced when used as a mold release material. In a case where the product described above is an electronic material or the like, an effect of using the hexagonal boron nitride powder described above is more remarkable. The content of sodium and calcium in the hexagonal boron nitride powder, for example, may be adjusted in accordance with the composition of the raw material powder, acid washing, and the like. In the production of the hexagonal boron nitride powder, an alkaline metal or an alkaline-earth metal is generally used as an additive, and among them, sodium and calcium are generally used. Accordingly, such elements are easily exposed in the hexagonal boron nitride powder. Accordingly, it is preferable to reduce the total content of sodium and calcium from the viewpoint of further improving the effect as described above. In addition, the content of sodium may be 30 ppm or less, 20 ppm or less, or 10 ppm or less, and the content of calcium may be 40 ppm or less, 30 ppm or less, or 20 ppm or less, while adjusting the sum of sodium and calcium in the range described above.

The hexagonal boron nitride powder may contain other metal elements, in addition to sodium and calcium, in accordance with a preparation method or the like. Examples of the other metal elements include manganese, iron, nickel, and the like. In the hexagonal boron nitride powder, it is preferable that the content of the other metal elements is also low. In the hexagonal boron nitride powder, the content of each of manganese, iron, and nickel may be 20 ppm or less, 10 ppm or less, or 5 ppm or less. In addition, the content of each of manganese, iron, and nickel may be less than or equal to a detection limit according to a detection device.

Herein, the content of the metal in the hexagonal boron nitride powder is measured by a pressurized acidolysis method of an ICP emission spectrometry.

The hexagonal boron nitride powder may contain an agglomerate in which a plurality of primary particles are aggregated, in accordance with a preparation method or the like. In a case where the hexagonal boron nitride powder contains the agglomerate described above, the content of the agglomerate, for example, may be 8 mass % or less, 5 mass % or less, 3 mass % or less, or 1.5 mass % or less, on the basis of the total amount of the hexagonal boron nitride powder. Since the content of the agglomerate is in the range described above, for example, a mold release layer more excellent in homogeneousness may be formed, and mold release properties of the mold release layer may be improved when used as a mold release material. It is preferable that the hexagonal boron nitride powder does not contain the agglomerate described above.

The hexagonal boron nitride powder, for example, may be produced by the following method. One embodiment of a production method for a hexagonal boron nitride powder includes a first step of obtaining a heat-treated product by performing a heating treatment with respect to a raw material powder containing a carbon-containing compound and boron-containing compound in a gas atmosphere containing a compound having nitrogen atoms as a constituent element, at a pressure of 0.25 MPa or more and less than 5.0 MPa and a temperature of 1600° C. or higher and lower than 1850° C., and a second step of obtaining a hexagonal boron nitride powder by firing the heat-treated product at a temperature higher than that in the first step described above.

The first step is a step of generating boron nitride by pressurizing and heating the raw material powder in the presence of the compound having nitrogen atoms as a constituent element. The raw material powder contains the carbon-containing compound and the boron-containing compound.

The carbon-containing compound is a compound having carbon atoms as a constituent element. The carbon-containing compound forms the boron nitride by a reaction with the boron-containing compound and the compound having nitrogen atoms as a constituent element. A raw material that has a high purity and is comparatively less expensive may be used as the carbon-containing compound. Examples of such a carbon-containing compound include carbon black, acetylene black, and the like.

The boron-containing compound is a compound having boron as a constituent element. The boron-containing compound is a compound that forms the boron nitride by a reaction with the carbon-containing compound and the compound having nitrogen atoms as a constituent element. A raw material that has a high purity and is comparatively less expensive can be used as the boron-containing compound. Examples of such a boron-containing compound include a boric acid, boron oxide, and the like.

In a case where the boron-containing compound contains a boric acid, the production method described above, for example, may include a step of preparing the raw material powder, and the step of preparing the raw material powder may include a step of dehydrating the boron-containing compound. By including the step of dehydrating the boron-containing compound, it is possible to improve the yield of the boron nitride to be obtained in the first step.

The raw material powder may contain other compounds, in addition to the carbon-containing compound and the boron-containing compound. Examples of the other compounds include a boron nitride powder as a nucleator, and the like. Since the raw material powder contains the boron nitride powder as a nucleator, an average particle diameter of the boron nitride powder to be synthesized may be more easily controlled. It is preferable that the raw material powder contains a nucleator. In a case where the raw material powder contains a nucleator, the specific surface area of the boron nitride powder is easily adjusted, and the boron nitride powder having a specific surface area of less than 2.0 m²/g is more easily produced.

In a case of using the boron nitride powder as a nucleator, the content of the boron nitride powder as a nucleator, for example, may be 0.05 to 8 parts by mass, on the basis of 100 parts by mass of the raw material powder. By setting a lower limit value of the content of the nucleator to 0.05 parts by mass or more, it is possible to further improve an effect of containing the nucleator. By setting an upper limit value of the content of the nucleator to 8 parts by mass or less, it is possible to improve the yield of the boron nitride powder.

The compound having nitrogen atoms as a constituent element is a compound that forms the boron nitride by a reaction with the carbon-containing compound and the boron-containing compound. Examples of the compound having nitrogen atoms as a constituent element include nitrogen, ammonia, and the like. The compound having nitrogen atoms as a constituent element may be supplied in the form of gas (also referred to as nitrogen-containing gas). It is preferable that the nitrogen-containing gas includes nitrogen gas, and it is more preferable that the nitrogen-containing gas is nitrogen gas, from the viewpoint of accelerating the formation of the boron nitride by a nitriding reaction and from the viewpoint of reducing the cost. In a case of using mixed gas of a plurality of gaseous bodies as the nitrogen-containing gas, a ratio of the nitrogen gas in the mixed gas may be preferably 95 volume/volume % or more.

The first step is performed under pressure. A lower limit value of the pressure in the first step is 0.25 MPa or more, and for example, may be 0.30 MPa or more, or 0.50 MPa or more. By setting the lower limit value of the pressure in the first step to be in the range described above, it is possible to suppress the generation of boron carbide as a by-product, and to suppress an increase in the specific surface area of the boron nitride powder. An upper limit value of the pressure in the first step is less than 5.0 MPa, and for example, may be 4.0 MPa or less, 3.0 MPa or less, 2.0 MPa or less, 1.0 MPa or less, or less than 1.0 MPa. By setting the upper limit value of the pressure in the first step to be in the range described above, it is possible to suppress a decrease in a volatilization amount of boron oxide, and to shorten a firing time. The pressure in the first step may be adjusted in the range described above, and for example, may be 0.25 MPa or more and less than 5.0 MPa, 0.25 to 1.0 MPa, or 0.25 MPa or more and less than 1.0 MPa.

The first step is performed under heat. A lower limit value of a heating temperature in the first step is 1600° C. or higher, and for example, may be 1650° C. or higher, or 1700° C. or higher. By setting the lower limit value of the heating temperature in the first step to be in the range described above, it is possible to improve the yield of the boron nitride to be obtained in the first step by accelerating the reaction of the raw material powder. In addition, by setting the lower limit value of the heating temperature in the first step to be in the range described above, it is possible to more sufficiently remove metal elements such as sodium and calcium (metal elements to be impurity metal elements) that may be mixed into the raw material powder to the outside of a system. An upper limit value of the heating temperature in the first step, for example, is lower than 1850° C., and for example, may be 1800° C. or lower, or 1750° C. or lower. By setting the upper limit value of the heating temperature in the first step to be in the range described above, it is possible to sufficiently suppress the generation of a by-product. The heating temperature in the first step may be adjusted in the range described above, and for example, may be 1650° C. or higher and lower than 1850° C., or 1650 to 1800° C. In the first step, a temperature increase rate is not particularly limited, and for example, may be 0.5° C./minute or more.

A heating time in the first step, for example, may be 2 hours or longer, or 3 hours or longer. In addition, the heating time in the first step, for example, may be 12 hours or shorter, 10 hours or shorter, or 8 hours or shorter. The heating time in the first step may be adjusted in the range described above, and for example, may be 2 to 12 hours, or 2 to 10 hours. Note that, herein, the heating time indicates a time for maintaining the temperature in the ambient environment of a heating target after reaching a predetermined temperature.

The second step is a step of growing and decarburizing primary particles of boron nitride with improved crystallizability (primary particles of hexagonal boron nitride) by pressurizing and heating the heat-treated product containing the boron nitride obtained in the first step at a high temperature in the presence of the compound having nitrogen atoms as a constituent element. The primary particles of the hexagonal boron nitride to be obtained by grain growth are in the shape of a scale.

The second step is performed under pressure. The pressure in the second step may be identical to or different from that in the first step. A lower limit value of the pressure in the second step, for example, may be 0.25 MPa or more, 0.30 MPa or more, or 0.50 MPa or more. By setting the lower limit value of the pressure in the second step to be in the range described above, it is possible to further improve the purity of the hexagonal boron nitride powder to be obtained. An upper limit value of the pressure in the second step is not particularly limited, and for example, may be less than 5.0 MPa, 4.0 MPa or less, 3.0 MPa or less, 2.0 MPa or less, 1.0 MPa or less, or less than 1.0 MPa. By setting the upper limit value of the pressure in the second step to be in the range described above, it is possible to further reduce a production cost of the hexagonal boron nitride powder, which is industrially predominant. The pressure in the second step may be adjusted in the range described above, and for example, may be 0.25 MPa or more and less than 5.0 MPa, 0.25 to 1.0 MPa, or 0.25 MPa or more and less than 1.0 MPa.

A heating temperature in the second step is set to a temperature higher than that in the first step. A lower limit value of the heating temperature in the second step, for example, may be 1850° C. or higher, or 1900° C. or higher. By setting the lower limit value of the heating temperature in the second step to be in the range described above, it is possible to further improve the purity of the hexagonal boron nitride, and to further decrease the specific surface area of the hexagonal boron nitride powder by accelerating the growth of the primary particles. An upper limit value of the heating temperature in the second step, for example, may be 2050° C. or lower, or 2000° C. or lower. By setting the upper limit value of the heating temperature in the second step to be in the range described above, it is possible to suppress the yellowing of the hexagonal boron nitride. The heating temperature in the second step may be adjusted in the range described above, and for example, may be 1850 to 2050° C., or 1900 to 2025° C.

A heating time in the second step (a high-temperature firing time), for example, may be 0.5 hours or longer, or 1 hour or longer. By setting the heating time in the second step to be in the range described above, it is possible to further improve the purity of the hexagonal boron nitride, and to more sufficiently grow the primary particles. In addition, the heating time in the second step, for example, may be 30 hours or shorter, or 25 hours or shorter. By setting the heating time in the second step to be in the range described above, it is possible to produce the hexagonal boron nitride powder at a lower cost. The heating time in the second step may be adjusted in the range described above, and for example, may be 0.5 to 30 hours, or 0.5 to 25 hours.

The production method described above may include other steps, in addition to the first step and the second step. Examples of the other steps include the step of preparing the raw material powder, the step of dehydrating the raw material powder, a step of pressurizing and molding the raw material powder, and the like. In a case where the production method described above includes the step of pressurizing and molding the raw material powder, the firing may be performed in an environment where the raw material powder exists at a high density, and the yield of the boron nitride to be obtained in the first step may be improved.

The production method for a hexagonal boron nitride powder can be referred to as a production method to which a so-called carbon reduction method is applied. According to the production method described above, it is possible to easily obtain the hexagonal boron nitride powder in which the average particle diameter of the primary particles and the specific surface area are adjusted. The primary particles of the hexagonal boron nitride to be obtained tend to be thick primary particles, compared to a case of using the other preparation method, and it is assumed that this is the reason why the specific surface area is easily adjusted.

Some embodiments have been described above, but the present disclosure is not limited to the embodiments described above. In addition, the contents of the embodiments described above can be applied to each other.

### EXAMPLES

Hereinafter, the present disclosure will be described in more detail with reference to Examples and Comparative Examples. Note that, the present disclosure is not limited to the following Examples.

### Example 1

[Preparation of Hexagonal Boron Nitride Powder]

100 parts by mass of a boric acid (manufactured by Kojundo Chemical Laboratory Co., Ltd.) and 25 parts by mass of acetylene black (Grade Name: HS100, manufactured by Denka Company Limited) were mixed with a Henschel mixer to obtain a mixed powder (a raw material powder). The obtained mixed powder was put in a drier at 250° C., and retained for 3 hours to dehydrate the boric acid. 200 g of the mixed powder after dehydration was put in a mold having a diameter of 100 Φ of a press molding machine, and molded in a condition of Heating Temperature: 200° C. and Press Pressure: 30 MPa. A molded body of the raw material powder obtained as described above was used in firing.

The molded body described above was left to stand in a carbon atmosphere furnace, heated up to 1800° C. at Temperature Increase Rate: 5° C./minute in a nitrogen atmosphere pressurized at 0.8 MPa, and retained at 1800° C. for 3 hours to perform a heating treatment with respect to the molded body described above (a first step). After that, the carbon atmosphere furnace was further heated up to 2000° C. at Temperature Increase Rate: 5° C./minute, and retained at 2000° C. for 7 hours to fire a heat-treated product of the molded body described above at a high temperature (a second step). Loosely aggregated boron nitride after firing was crushed with a Henschel mixer, and passed through a sieve having Mesh Size: 75 μm to obtain a powder that had passed through the sieve. Accordingly, a hexagonal boron nitride powder was prepared.

[Properties of Hexagonal Boron Nitride Powder]

For the hexagonal boron nitride powder obtained as described above, the purity of the powder, a specific surface area of the powder, an average particle diameter of primary particles, and the total content of calcium and sodium in the powder were measured. Specifically, the measurement was performed by a method described below. Results are shown in Table 1.

<Purity of Hexagonal Boron Nitride Powder>

The purity of the hexagonal boron nitride powder was obtained by the following method. Specifically, first, a sample was subjected to alkaline decomposition with sodium hydroxide, and ammonia was distilled from a decomposed liquid by a steam distillation method, and collected in a boric acid aqueous solution. Titration was performed with a sulfuric acid normal solution by using a collecting liquid as a target to obtain the content of nitrogen atoms (N) in the sample described above. After that, the content of hexagonal boron nitride (hBN) in the sample was determined on the basis of Expression (1) described below, and the purity of the hexagonal boron nitride powder was calculated.

Content[mass %] of Hexagonal Boron Nitride(hBN) in Sample=Content[mass %] of Nitrogen Atoms(N)×1.772 (1)

Note that, 24.818 g/mol was used as a formula weight of the hexagonal boron nitride, and 14.006 g/mol was used as an atomic weight of nitrogen atoms.

<Specific Surface Area of Hexagonal Boron Nitride Powder>

The specific surface area of the hexagonal boron nitride powder containing an aggregated body of the primary particles was measured by using a measurement device, on the basis of a method described in JIS Z 8803:2013. The specific surface area is a value calculated by applying a BET one point method using nitrogen gas.

<Average Particle Diameter of Primary Particles: Median Size (d50)>

The average particle diameter of the primary particles in the hexagonal boron nitride powder was measured. The average particle diameter of the primary particles of the hexagonal boron nitride was measured by using a particle size distribution measurement device (Product Name: MT3300EX, manufactured by NIKKISO CO., LTD.), on the basis of a method described in ISO 13320:2009. Note that, the obtained average particle diameter is an average particle diameter according to a volume statistical value, and is a median value (d50). In the particle size distribution measurement, water was used as a solvent in which the aggregated body was dispersed, and a hexametaphosphoric acid was used as a dispersant. At this time, a numerical value of 1.33 was used as a refractive index of water, and a numerical value of 1.80 was used as a refractive index of the hexagonal boron nitride powder.

<Total Content of Calcium and Sodium in Hexagonal Boron Nitride Powder>

The content of calcium and sodium in the hexagonal boron nitride powder was measured by a pressurized acidolysis method of an ICP emission spectrometry. The total value of calcium and sodium was set to the total content. Note that, in Table 1 and Table 2, “N.D.” indicates that elements to be measured are less than or equal to a detection limit value.

[Evaluation as Mold Release Material Using Hexagonal Boron Nitride Powder]

Evaluation as a mold release material of the hexagonal boron nitride powder obtained as described above (the evaluation of mold release properties) was performed. First, a molded body to be a target onto which the mold release material was applied was prepared as follows. 2.5 mol % of yttria was added to a silicon nitride powder having Amount of Oxygen: 1.0% and Specific Surface Area: 10 m²/g, methanol was added thereto, and wet mixing was performed with a wet ball mill for 5 hours to obtain a mixture. The obtained mixture was filtered, and a filtrate was dried to obtain a mixed powder. A mold was filled with the mixed powder described above, and subjected to metallic molding at a molding pressure of 20 MPa, and then, subjected to CIP molding at a molding pressure of 200 MPa to prepare a plate-shaped molded body (5 mm×50 mm×50 mm).

Next, the hexagonal boron nitride powder obtained as described above was dispersed in a normal hexane solution, and slurry of Concentration: 1 mass % was prepared. The prepared slurry was applied onto both surfaces of the molded body described above to have a thickness of 10 μm, and dried to prepare a base material including a mold release layer. 30 base materials were prepared by the same method, and a block was prepared in which 30 base materials were stacked. The block was left to stand in an electric furnace including a carbon heater, and fired for 6 hours in a condition of 1900° C. and 0.9 MPa. The peeled surface of the base materials after firing was subjected to visual observation, and the mold release properties were evaluated on the basis of the following criteria. A indicates that the mold release properties are most excellent.

A: All the base materials were naturally mold-released, and black spots derived from impurities were not seen on the peeled surface of the base material.

B: All the base materials were naturally mold-released, and the black spots derived from impurities were slightly seen on the peeled surface of the base material.

C: The base materials were not mold-released, or the black spots derived from impurities were seen on the peeled surface of the base material.

### Example 2

In Example 2, a hexagonal boron nitride powder was produced as with Example 1, except that the heating temperature in the second step was 1900° C. Evaluation results of the hexagonal boron nitride powder of Example 2 were shown in Table 1.

### Example 3

In Example 3, a hexagonal boron nitride powder was produced as with Example 1, except that the pressure in the first step and the second step was 0.3 MPa. Evaluation results of the hexagonal boron nitride powder of Example 3 were shown in Table 1.

### Example 4

In Example 4, a hexagonal boron nitride powder was produced as with Example 1, except that 1 part by mass of hexagonal boron nitride (Grade Name: GP, manufactured by Denka Company Limited) was further compounded to the raw material powder of Example 1 as a nucleator. Evaluation results of the hexagonal boron nitride powder of Example 4 were shown in Table 1.

### Example 5

In Example 5, a hexagonal boron nitride powder was produced as with Example 1, except that the hexagonal boron nitride powder obtained in Example 1 was further subjected to jet mill pulverization in a pulverization condition of Pulverization Pressure: 0.2 MPa by using a jet pulverizer (Product Name: PJM-80, manufactured by DAIICHI JITSUGYO CO., LTD.). Evaluation results of the hexagonal boron nitride powder of Example 5 were shown in Table 1.

### Example 6

In Example 6, a hexagonal boron nitride powder was produced as with Example 1, except that 10 parts by mass of hexagonal boron nitride (Grade Name: SGP, manufactured by Denka Company Limited) was further compounded to the raw material powder of Example 1 as a nucleator, and the heating time in the second step was 40 hours. Evaluation results of the hexagonal boron nitride powder of Example 6 were shown in Table 1.

### Comparative Example 1

A commercially available hexagonal boron nitride powder was set to Comparative Example 1. Evaluation results of the hexagonal boron nitride powder of Comparative Example 1 were shown in Table 2.

### Comparative Example 2

In Comparative Example 2, a hexagonal boron nitride powder was produced as with Example 1, except that the heating temperature in the second step was changed to 1800° C. from 2000° C. Evaluation results of the hexagonal boron nitride powder of Comparative Example 2 were shown in Table 2.

### Comparative Example 3

In Comparative Example 3, a hexagonal boron nitride powder was produced as with Example 1, except that the pressure in the first step and the second step was 0.2 MPa. Evaluation results of the hexagonal boron nitride powder of Comparative Example 3 were shown in Table 2. Note that, in the production condition of Comparative Example 3, the degree of contamination in the furnace was higher than that of Example 1.

TABLE 1

| | | Example 1 | Example 2 | Example 3 | Example 4 | Example 5 | Example 6 |
|---|---|---|---|---|---|---|---|
| Hexagonal | Purity [mass %] | 99.5 | 98.5 | 99.5 | 99.5 | 99.0 | 99.5 |
| boron nitride | Specific surface area [m²/g] | 1.3 | 1.3 | 1.9 | 0.5 | 1.9 | 0.1 |
| powder | Average particle diameter [μm] | 9.2 | 9.5 | 9.3 | 20 | 4.5 | 35 |
| | Content of sodium [ppm] | N.D. | 2 | N.D. | N.D. | N.D. | N.D. |
| | Content of calcium [ppm] | 2 | 4 | 2 | 2 | 2 | 2 |
| | Total content of sodium and | 2 | 6 | 2 | 2 | 2 | 2 |
| | calcium [ppm] | | | | | | |
| Evaluation | Mold release properties | A | A | A | A | A | B |

TABLE 2

| | | Comparative | Comparative | Comparative |
|---|---|---|---|---|
| | | Example 1 | Example 2 | Example 3 |
| Hexagonal | Purity [mass %] | 98.0 | 96.0 | 99.0 |
| boron | Specific surface | 6.0 | 1.3 | 2.5 |
| nitride | area [m²/g] | | | |
| powder | Average particle | 8.2 | 9.5 | 9.1 |
| | diameter [μm] | | | |
| | Content of | 10 | 2 | N.D. |
| | sodium [ppm] | | | |
| | Content of | 20 | 5 | 5 |
| | calcium [ppm] | | | |
| | Total content of | 30 | 7 | 5 |
| | sodium and | | | |
| | calcium [ppm] | | | |
| Evaluation | Mold release | C | C | C |
| | properties | | | |

### INDUSTRIAL APPLICABILITY

According to the present disclosure, it is possible to provide a versatile hexagonal boron nitride powder. In addition, according to the present disclosure, it is possible to provide a production method for the hexagonal boron nitride powder as described above.

1. A hexagonal boron nitride powder having a purity of 98 mass % or more and a specific surface area of less than 2.0 m²/g.

2. The hexagonal boron nitride powder according to claim 1,
wherein a total content of sodium and calcium is less than 50 ppm.

3. The hexagonal boron nitride powder according to claim 2,
wherein the total content of sodium and calcium is 30 ppm or less.

4. The hexagonal boron nitride powder according to claim 1,
wherein an average particle diameter of primary particles is 2.0 to 35 μm.

5. The hexagonal boron nitride powder according to claim 4,
wherein the average particle diameter of the primary particles is 9.0 to 30 μm.
